(19) United States
(12) Patent Application Publication
(10) Pub. No.: US 2005/0243105 A1
(43) Pub. Date: Nov. 3, 2005

(54) Systems and methods for the processing of digital files

(75) Inventors: Nathan Fjeld, Coon Rapids, MN (US); Jeff Urban, Minneapolis, MN (US); Nathan Coltvet, Lino Lakes, MN (US)

Correspondence Address: SCHWEGMAN, LUNDBERG, WOESSNER & KLUTH, P.A., P.O. BOX 2938, MINNEAPOLIS, MN, 55402-0938, US

(73) Assignee: Liberty Enterprises, Inc.

(21) Appl. No.: 10/837,813

(22) Filed: May 3, 2004

(51) Int. Cl. G06K 5/00

(52) U.S. Cl. 345/660

(57) ABSTRACT

Systems and methods for the processing of digital files, such as digital images, for use on card devices, such as financial cards, identification cards or smart cards, are provided. In an exemplary method, a system receives a digital image, analyzes the image, re-dimensions or re-sizes the image as necessary, and prompts the user for approval of the altered image. The approved image can be used to produce photo-ID card devices, including sending the approved image to a production facility capable of producing photo-ID card devices. In a further embodiment, the system receives a compressed collection of files, which the system uncompresses before beginning analysis.

### FIELD OF THE INVENTION

The present invention relates to a method for processing photographs for picture ID's, such as in the form of digital images, for use in a printing process and more particularly for use in a process for manufacturing or preparing card devices.

### BACKGROUND

The use or misuse of stolen or counterfeit financial cards is an ever-present problem. Widely used financial cards store information encrypted on the back, which typically identifies the account number of an authorized holder. Such information can be machine read at a merchant location for verification that it is a valid number. Further communication with the issuing institution can verify that the account is open and that there is a sufficient balance in the account to cover the transaction.

The attendant at the merchant location may choose to further identify the person presenting the card to validate that the presenter of the card is the proper owner. The attendant may choose to ask that the person presenting the financial card provide a form of government issued identification. The attendant can then verify that the names and/or signatures match.

The attendant may also verify that the photo on the government issued identification matches that of the person presenting the financial card. Such government issued identification can be fraudulently obtained or fabricated. Such forgeries can pass the scrutiny of an attendant and be accepted as valid. An attendant can perform further verification by comparing the image on the financial card with the person presenting it.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is an illustration of a system according to an embodiment of the inventive subject matter contained herein.

FIG. 2A is a flowchart of a method according to an embodiment of the inventive subject matter contained herein.

FIG. 2B is a flowchart of a method according to an embodiment of the inventive subject matter contained herein.

FIG. 3 is a flowchart of a method according to an embodiment of the inventive subject matter contained herein.

FIG. 4 is a flowchart of a method according to an embodiment of the inventive subject matter contained herein.

FIG. 5 is an illustration of a system according to an embodiment of the inventive subject matter contained herein.

FIG. 6A-6G are screenshots of example user interface screens according to an embodiment of the inventive subject matter contained herein.

### DETAILED DESCRIPTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the inventive subject matter disclosed herein. Therefore, the following detailed description is not to be taken in a limiting sense, and the scope of the inventive subject matter disclosed herein is defined by the appended claims and their equivalents.

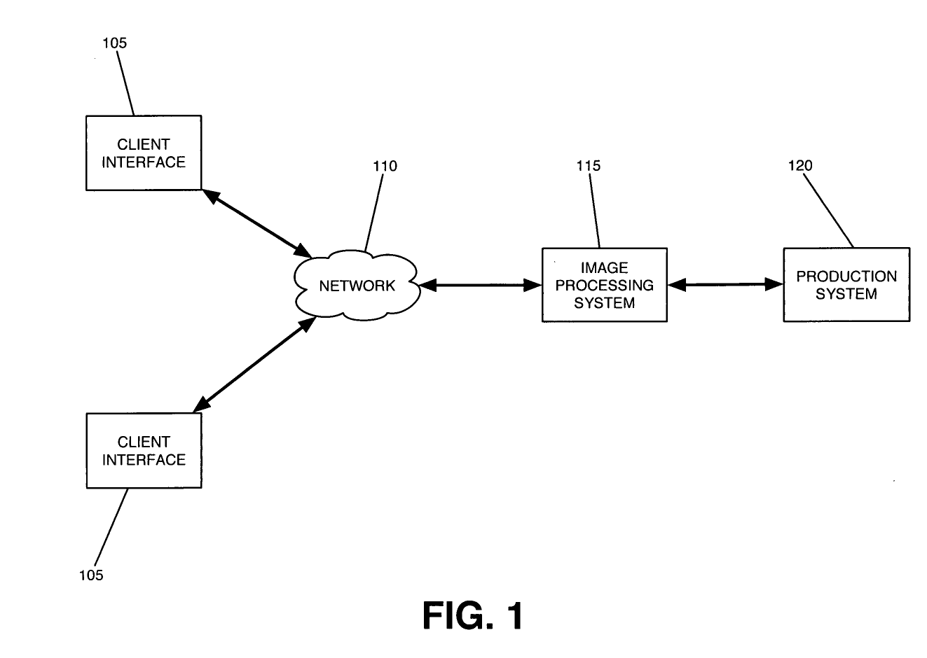

FIG. 1 depicts a system for the processing of images according to an embodiment of the inventive subject matter contained herein. In an embodiment, a user submits files at a client interface 105. In one embodiment, the files are digital images. The files are transmitted via some network 110 to an image processing system 115. The network 110 may be, without limitation, a local area network (LAN), a wide area network (WAN), the Internet, a private computer network or a public computer network. The image processing system 115 performs operations on the file. The operations may include, without limitation, re-dimensioning and re-sizing. Re-sizing includes, for example, changing the resolution of the file, changing the width and height of the file and changing the color depth of the file. The image processing system 115 transmits the file to a production system 120. In one example embodiment, the production system is a production facility capable of producing card devices, such as financial cards or photo-ID cards.

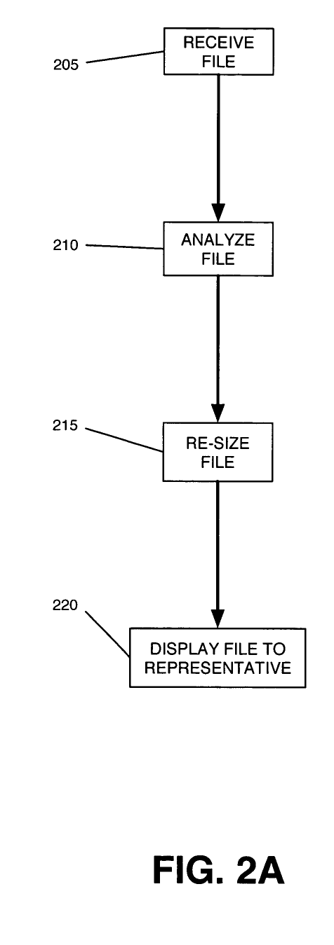

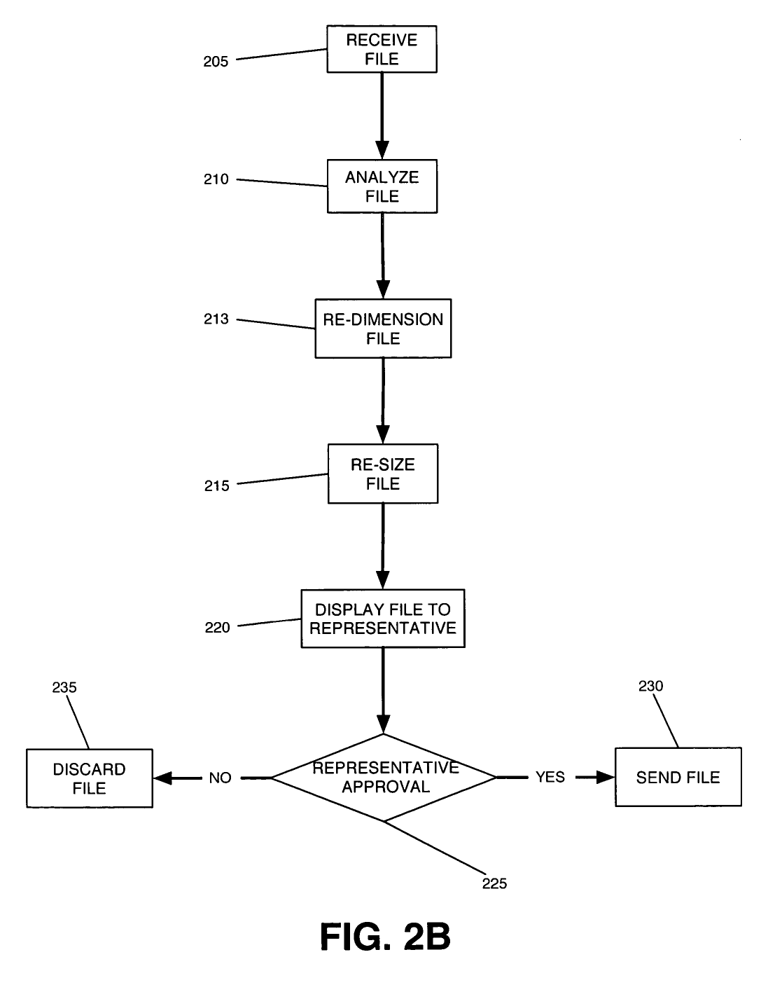

FIG. 2A depicts at a high level a method for processing a file according to another embodiment of the present invention. At 205 a system, such as the image processing system 115 of FIG. 1, obtains a file. In an embodiment, the file is a photograph of at least one card user of an institution. In an embodiment, the system obtains the file from a representative of an institution, such as a financial institution. In one embodiment, the file is a single image file. In another embodiment, the file is series of image files. In a further embodiment, the file is a compressed collection of image files, such as a ZIP® compressed file. In another embodiment, the file is a series of image files compressed by any other suitable means, such as TAR, self-extracting archive (SEA), or gzip. At 210 the system analyzes the attributes of the file. The attributes include, without limitation, dimensions, color depth and resolution. At 215 the system resizes the file. In an embodiment, resizing includes, without limitation, altering any of the attributes so that those attributes match some pre-set values. As an example, the system receives a file that is 192 pixels wide by 180 pixels high. In such an example, the pre-set value for dimensions is 180×180 pixels. In this example, the system alters the width of the image to 180 pixels, such that the resulting image is 180 pixels wide by 180 pixels high. At 220 the system displays the file to the representative of the institution. If the representative of the institution accepts the altered file, that file is used to produce a photo-ID card for the card user. In an alternate embodiment, the file can be sent to a facility capable of producing photo-ID cards.

FIG. 2B depicts at a high level a method for processing a file according to another embodiment of the inventive subject matter contained herein. At 205 a system, such as the image processing system 115 of FIG. 1, receives a file. In an embodiment, the system receives the file from a representative of an institution, such as a financial institution. At 210 the system analyzes the attributes of the file. At 213 the system re-dimensions the file such that the resulting file's width and height are substantially equal. At 215 the system re-sizes the file further. In still another embodiment, re-sizing includes, without limitation, altering any of the attributes so that those attributes match some pre-set values. At 220 the system displays to the representative of the institution the re-dimensioned and re-sized file. At 225 the user has the opportunity to accept the system's re-dimensioning and re-sizing. If the representative of the institution accepts the altered file, that file is used to produce a photo-ID card for the card user. In an alternate embodiment, the file can be sent to a facility capable of producing photo-ID cards. If the representative of the institution does not approve, the file is discarded at 235. In an embodiment, the representative of the institution is prompted to re-submit the file. In a further embodiment, the representative of the institution is provided with information about preparing the file prior to submission. In such an embodiment, the representative of the institution can manipulate the file on their PC so that the future submission of the file results in no altering by the system.

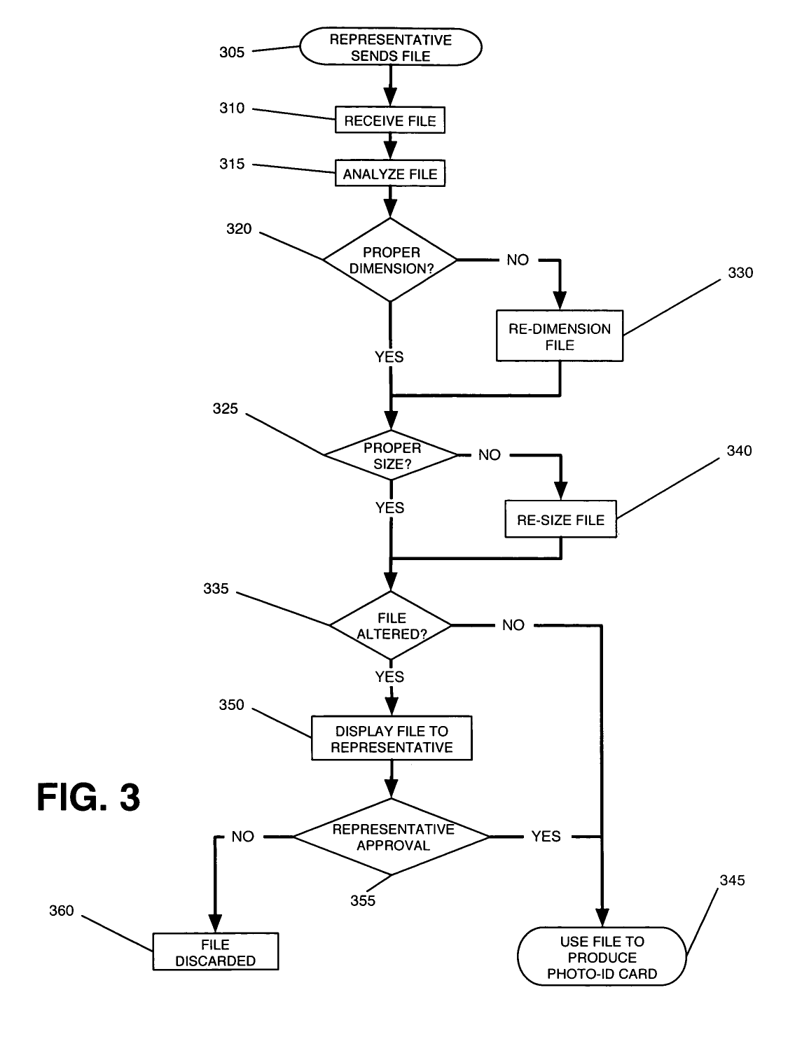

FIG. 3 depicts a method according to still another example embodiment for submitting a series of image files. The series of image files may be intended for use on card devices, such as photo-ID cards, financial cards, identification cards or smart cards. At 305 the representative of an institution sends a data item, such as a file. In one embodiment, the data item is a single image file. In an alternate embodiment, the data item is a series of image files. In a further embodiment, the data item is a compressed collection of image files. At 310 a system, such as the image processing system 115 of FIG. 1, receives the file from the representative of the institution. At 315 the system analyzes the attributes of the file. Attributes include, without limitation, dimensions, color depth and resolution. At 320 the system first checks the dimensions of the file. At 320 the system checks the proportionality of the height and width of the file. In another embodiment, the file should be as wide as it is high. If the dimensions of the file are substantially equal to some proportional value, the system proceeds to checking the size of the file at 325. If the dimensions of the file are not substantially equal to some proportional value, the system re-dimensions the file at 330 such that the resulting dimensions are substantially equal to some proportional value.

Subsequent to the re-dimensioning of the file at 330, the system proceeds to checking the size of the file at 325. At 325 the system checks that the file is of a proper size. Size includes, without limitation, resolution, color depth, and exact size. The system at 320 only checked the width of the file only as it related to its height. At 325 the system checks all attributes of the file, including the actual height and width of the file. In an embodiment, at 325 the system checks the height and width of the image in relation to some pre-set value. If the height and width of the image are substantially equal to some pre-set value, the system proceeds to 335. If the height and width of the image are not substantially equal to the pre-set value, the system resizes the image at 340. In a further embodiment, at 325 the system checks other attributes of the file against some pre-set values. In such an embodiment, if the attributes are not substantially equal to those pre-set values, the system re-sizes the file at 340.

Subsequent to re-sizing the image at 340, the system proceeds to 335. At 335 the system checks to see if the file has been altered in some manner. This includes the dimensions and size of the file. If the file has not been altered, the system proceeds to 345 and sends the file to a production facility, such as the production system 120 of FIG. 1. If the file has been altered, the system displays the file to the user 350. If the user approves of the re-dimensioning or re-sizing of the file at 355 the file is used to produce a photo-ID card for the card user. In an alternate embodiment, the file can be sent to a facility capable of producing photo-ID cards. If the user does not approve of the re-dimensioning or re-sizing of the file at 355 the file is discarded 360. In an embodiment, the user is prompted to re-submit the file. In a further embodiment, the user is provided with information as to preparing the file prior to submission. In such an embodiment, the user can manipulate the file on their PC so that the future submission of the file results in no altering by the system.

In yet another embodiment, the system handles more then one file at a time, such that the processing and customer approval of more then one file occur concurrently. In such an embodiment, the user has sent more then one file at 305. At 350 the system simultaneously displays all the files that have been received from the user that have been altered, such as by re-dimensioning at 330 or re-sizing at 340. At 355 the system receives either the user's approval or disapproval for all files that have been altered at substantially the same time. In such an embodiment, the user may be presented with all the files on a single user interface screen with a checkbox under each file indicating whether that file is acceptable or not.

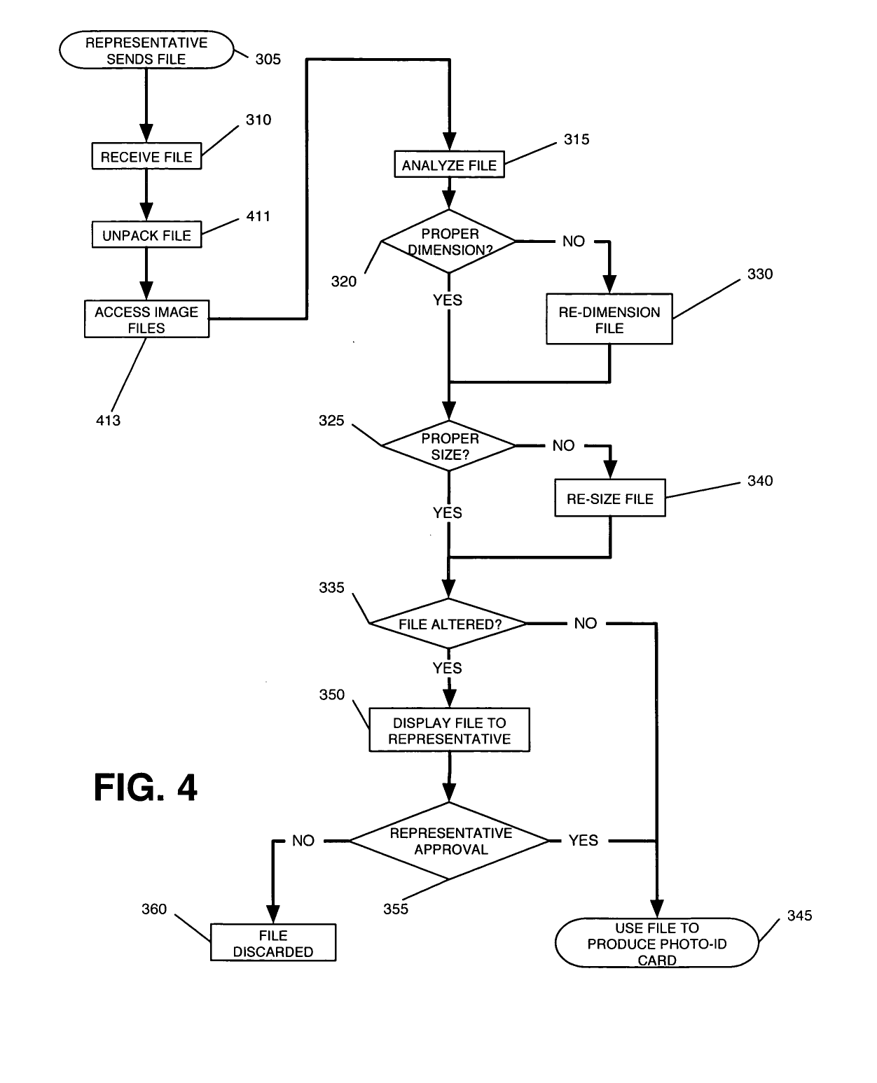

FIG. 4 depicts a method according to an embodiment of the inventive subject matter contained herein. FIG. 4 is substantially similar to FIG. 3 except in that the data item sent by the representative of the institution is not a single file or a series of files, but a compressed collection of files. In an embodiment, the compressed collection of files is compressed with a suitable compression technology. Compression technologies include, without limitation, ZIP, PKZIP, WINZIP, TAR, SEA, GZ or HQX. The system uncompresses, or unpacks, the compressed file at 411. Each image file is accessed at 413 and processed substantially the same as in FIG. 3. Following analysis and any altering of the file, all files that have been altered are displayed to the user at 350. In an embodiment, each file is displayed with checkboxes indicating approval or disapproval. In such an embodiment, the user selects whether the file as altered is acceptable. Files that are acceptable are user to produce photo-ID cards for the card users. In an alternate embodiment, files that are acceptable are sent to a facility capable of producing photo-ID cards.

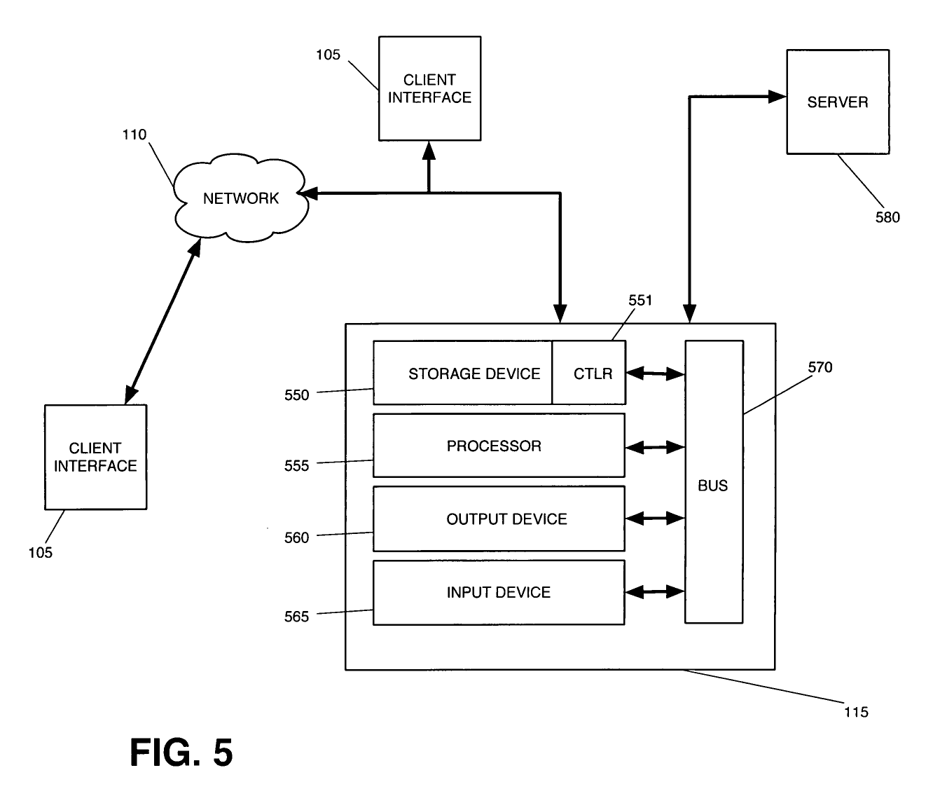

FIG. 5 depicts a system according to an embodiment of the inventive subject matter contained herein. In an embodiment, the system 115 depicted in FIG. 5 corresponds to the image processing system 115 of FIG. 1. The system 115 is connected over some communications link to client interfaces 105. In an embodiment, the client interface 105 is connected over a local area network to the image processing system 115. In another embodiment, the client interface 105 is connected to the image processing system over a Wide Area Network, such as the Internet. In yet another embodiment, the client interface 105 is connected to the image processing system 115 over any suitable communications network, or combination of suitable communications networks.

FIG. 5 depicts a block diagram of a system for implementing an embodiment of the invention analogous to the data processor 130 shown in FIG. 1. Illustrated are a server 580 connected to a system 115 via a network 110. Although one server 580, one system 115, and one network 110 are shown, in other embodiments any number or combination of them may be present. Although the server 580 and the network 110 are shown, in another embodiment they may not be present.

The system 115 may include a processor 555, a storage device 550, an input device 565, and an output device 560, all connected via a bus 570.

The processor 555 may represent a central processing unit of any type of architecture, such as CISC (Complex Instruction Set Computing), RISC (Reduced Instruction Set Computing), VLIW (Very Long Instruction Word), or hybrid architecture, although any appropriate processor may be used. The processor 555 may execute instructions and may include that portion of the system 115 that controls the operation of the entire computer. Although not depicted in FIG. 5, the processor 555 typically includes a control unit that organizes data and program storage in memory and transfers data and other information between the various parts of the system 115. The processor 555 may receive data from the input device 565, may read and store code and data in the storage device 550, may send data to the output device 560, and may send and receive code and/or data to/from the network 110.

Although the system 115 is shown to contain only a single processor 555 and a single bus 570, the present invention applies equally to computers that may have multiple processors and to computers that may have multiple buses with some or all performing different functions in different ways.

The storage device 550 represents one or more mechanisms for storing data. For example, the storage device 550 may include read only memory (ROM), random access memory (RAM), magnetic disk storage media, optical storage media, flash memory devices, and/or other machine-readable media. In other embodiments, any appropriate type of storage device may be used. Although only one storage device 550 is shown, multiple storage devices and multiple types of storage devices may be present. Further, although the system 115 is drawn to contain the storage device 550, it may be distributed across other computers, for example on server 580.

The storage device 550 includes a controller 551, which in an embodiment may include instructions capable of being executed on the processor 555 to carry out the functions of the present invention. In another embodiment, some or all of the functions of the present invention may be carried out via hardware in lieu of a processor-based system. Although the controller 551 is shown to be contained within the storage device 550 in the system 115, some or all of the controller 551 may be distributed across other systems, for example on the server 580 and accessed via the network 110.

The input device 565 may be a keyboard, pointing device, mouse, trackball, touchpad, touchscreen, keypad, microphone, voice recognition device, or any other appropriate mechanism for the user to input data to the system 115. Although only one input device 565 is shown, in another embodiment any number and type of input devices may be present.

The output device 560 is that part of the system 115 that communicates output to a user. The output device 560 may be a cathode-ray tube (CRT) based video display well known in the art of computer hardware. But, in other embodiments the output device 560 may be replaced with a liquid crystal display (LCD) based or gas, plasma-based, flat-panel display. In another embodiment, the output device 560 may be a speaker. In still other embodiments, any appropriate output device suitable for presenting data may be used. Although only one output device 560 is shown, in other embodiments, any number of output devices of different types or of the same type may be present.

The bus 570 may represent one or more busses, e.g., PCI, ISA (Industry Standard Architecture), X-Bus, EISA (Extended Industry Standard Architecture), or any other appropriate bus and/or bridge (also called a bus controller).

The system 115 may be implemented using any suitable hardware and/or software, such as a personal computer or other electronic computing device. Portable computers, laptop or notebook computers, and mainframe computers are examples of other possible configurations of the system 115. The hardware and software depicted in FIG. 5 may vary for specific applications and may include more or fewer elements than those depicted. For example, other peripheral devices such as audio adapters or chip programming devices, such as EPROM (Erasable Programmable Read-Only Memory) programming devices may be used in addition to or in place of the hardware already depicted.

The network 110 may be any suitable network and may support any appropriate protocol suitable for communication between the server 580 and the system 115, as well as between the system 115 and the client interfaces 105. In an embodiment, the network 110 may support wireless communications. In another embodiment, the network 110 may support hard-wired communications, such as a telephone line or cable. In another embodiment, the network 110 may support the Ethernet IEEE (Institute of Electrical and Electronics Engineers) 802.3x specification. In another embodiment, the network 110 may be the Internet and may support IP (Internet Protocol). In another embodiment, the network 110 may be a local area network (LAN) or a wide area network (WAN). In another embodiment, the network 110 may be a hotspot service provider network. In another embodiment, the network 110 may be an intranet. In another embodiment, the network 110 may be a GPRS (General Packet Radio Service) network. In another embodiment, the network 110 may be any appropriate cellular data network or cell-based radio network technology. In another embodiment, the network 110 may be an IEEE 802.11x wireless network, where x is any alphanumeric character used to designate a specific standard. In still another embodiment, the network 110 may be any suitable network or combination of networks. Although one network 110 is shown, in other embodiments any number of networks (of the same or different types) may be present.

As was described in detail above, aspects of an embodiment pertain to specific apparatus and method elements implementable on a computer or other electronic device. In another embodiment, the invention may be implemented as a program product for use with an electronic device. The programs defining the functions of this embodiment may be delivered to an electronic device via a variety of signal-bearing media, which include, but are not limited to:

(1) information permanently stored on a non-rewriteable storage medium, e.g., a read-only memory device attached to or within an electronic device, such as a CD-ROM readable by a CD-ROM drive;

(2) alterable information stored on a rewriteable storage medium, e.g., a hard disk drive or diskette; or

(3) information conveyed to an electronic device by a communications medium, such as through a computer or a telephone network, including wireless communications.

Such signal-bearing media, when carrying machine-readable instructions that direct the functions of the present invention, represent embodiments of the present invention.

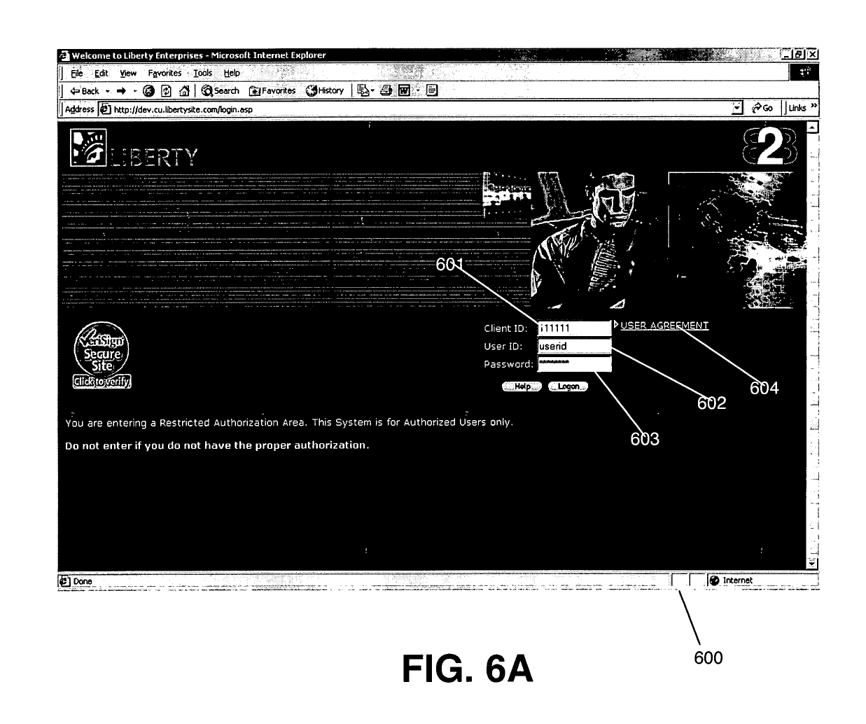

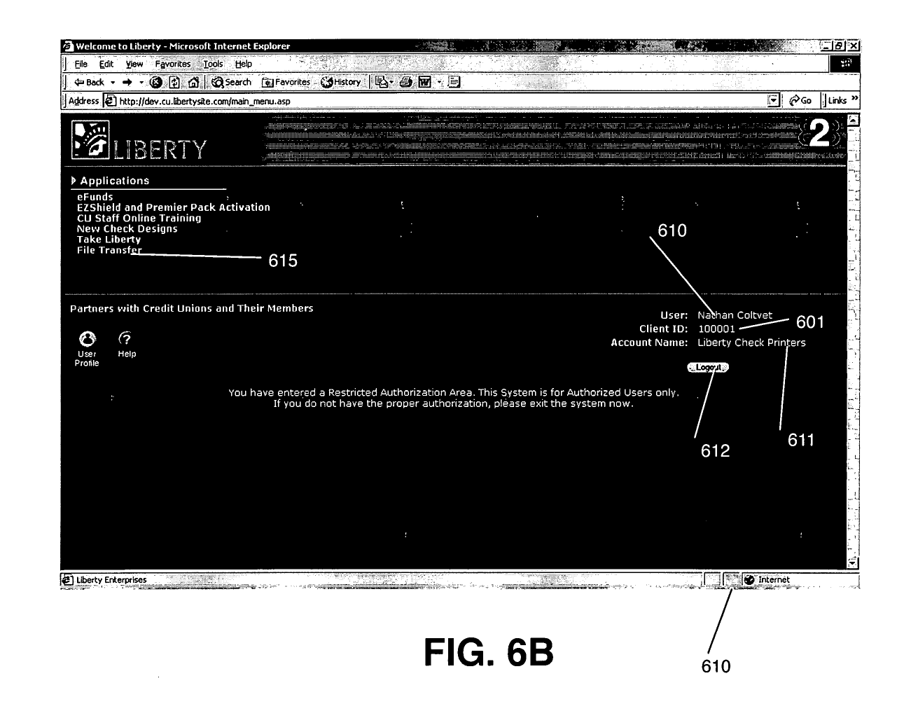

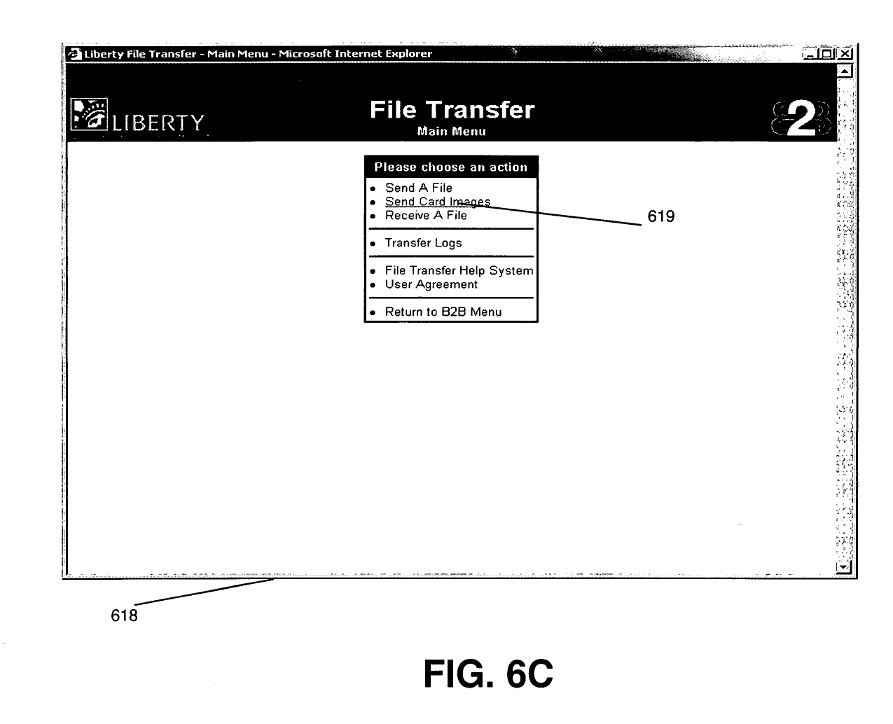

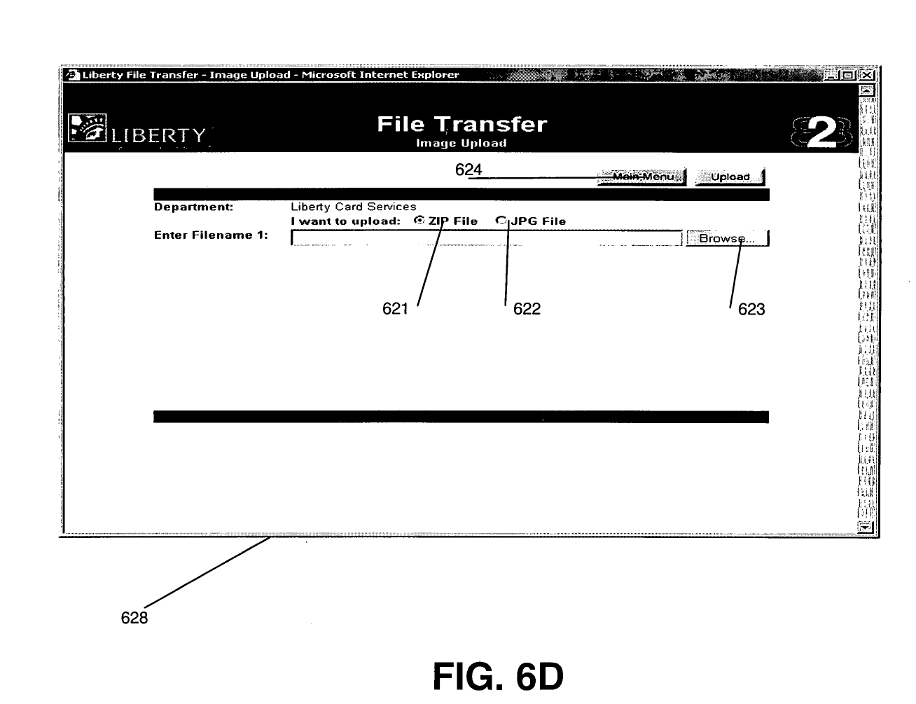

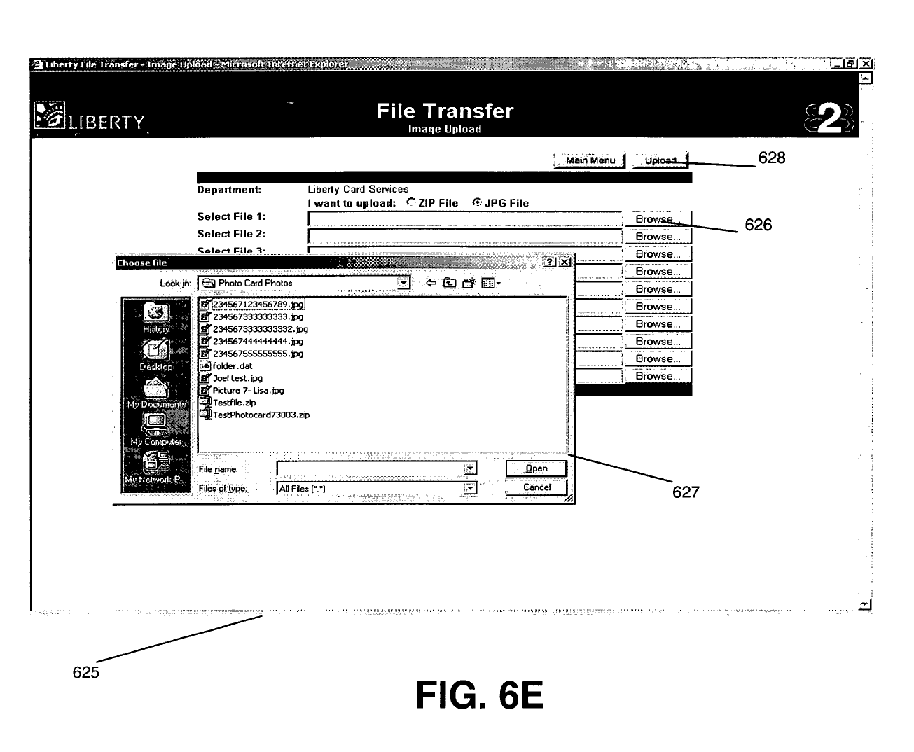

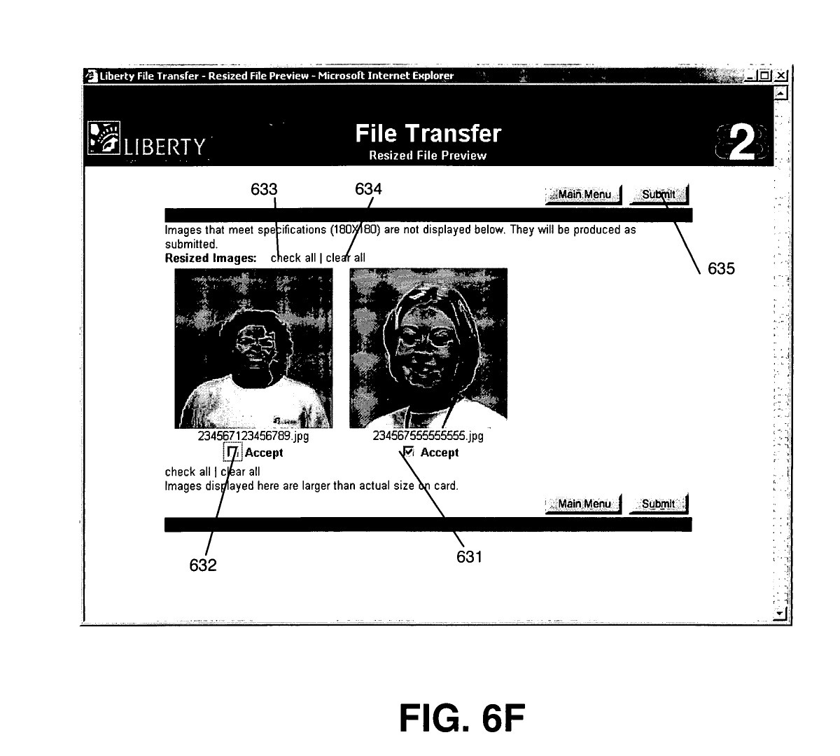

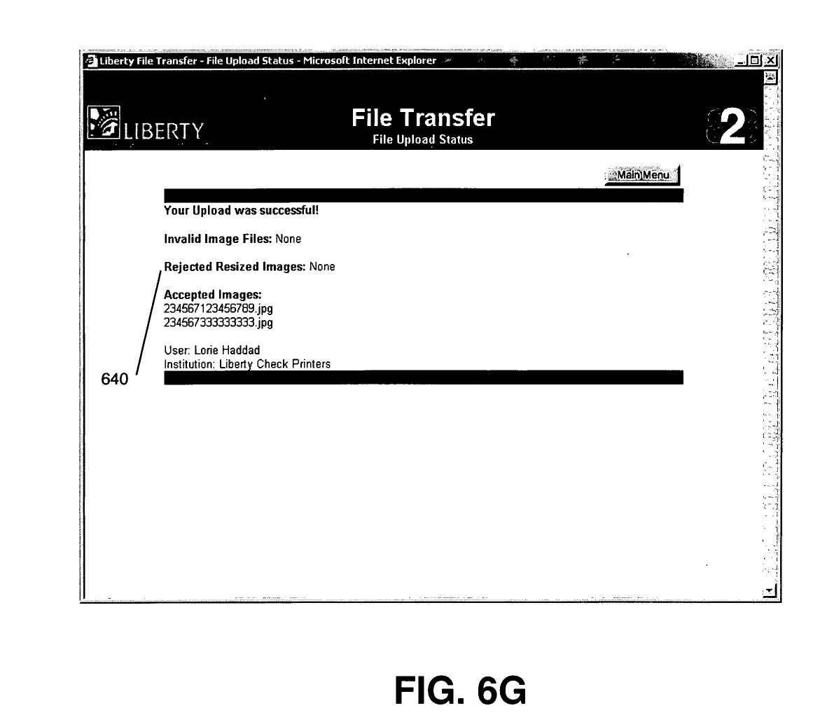

FIG. 6A-6G are screenshots of example user interface screens according to embodiments of the inventive subject matter contained herein. FIG. 6A depicts a login screen 600. It is to be understood, that the screens contained herein are being transmitted across some network from a system 115 or server 580 to a client interface 105. In an embodiment, a system, such as the image processing system 115 of FIG. 1 or the server 580 of FIG. 5, prompts the representative of an institution to supply their credentials for verification. In a further embodiment, the credentials include client id 601, user id 602 and password 603. It is understood that more then one representative of the institution may utilize the system contemplated herein. In such an embodiment, all representatives of the same institution can use the same client id 601 which identifies that institution. In an embodiment a link on the screen 400 is provided to the representative of an institution for access to a user agreement 604. In such an embodiment, the user agreement contains the obligations of representative of an institution and system provider.

Following a successful login on screen 600 of FIG. 6A, the system displays screen 610 of FIG. 6B to the representative of an institution. It is to be understood that though the term display is used, that this includes the transmission of a screen from a system, such as the image processing system 115 of FIG. 1, or a server, such as the server 580 of FIG. 5, over a network to some client interface, such as the client interface 105 of FIG. 1. The system displays information about the current login, such as the user 610, the client id 601 and the account name 611. The system also displays a clickable link allowing the representative of an institution to logout 612 from the system. In a further embodiment, clickable links are provided for other functions of the system or server, such as training links and informational links. A link to perform a file transfer is provided at 615. In an embodiment, the file transfer is a transfer of files as contemplated by the methods described above with reference to FIG. 2-FIG. 4.

FIG. 6C depicts an example user interface screen for file transfer 618. The representative of an institution selects the “Send Card Images” Link 619 to indicate their desire to transfer a single image file or series of image files. FIG. 6D depicts an example user interface screen for uploading of files 620. The representative of an institution indicates whether they wish to send a ZIP file 621 or a JPG File 622. A link provides the representative of an institution access to their local storage device 623 for the locating of the files they wish to transfer. A link is also provided so that the representative of an institution can return to the main menu 624.

FIG. 6E depicts an example user interface screen for the transferring of multiple jpg image files 625. In an embodiment, up to 20 jpg image files can be transferred. As is shown in FIG. 6E multiple links are provided for the locating of individual image files 626. A pop-up screen 627 can be displayed to the representative of an institution for the locating of files on their storage device. Once the representative of an institution has located all the files they wish to transfer, they affect the uploading of them to the system or server by clicking on the “upload” button 628.

In an embodiment, the system displays to the representative of an institution a single file entry line when a ZIP file is chosen to be transferred. This is depicted in FIG. 6D. In an alternate embodiment, when a jpg file is chosen to be transferred, multiple file entry lines are displayed, such as that depicted in FIG. 6E. The pop-up screen 627 can be used for the locating of both individual files and compressed file collections.

FIG. 6F depicts an example user interface screen for the approving of altered images, such as that contemplated by act 355 of FIG. 3 and FIG. 4. Each altered file is displayed to the representative of an institution. In the example provided for in FIG. 6F, two images are displayed. The representative of an institution in this example, chooses to accept the 234567666666666.jpg file and not accept the 234567123456789.jpg image as indicated by the presence of a checkmark in the checkbox adjacent to the displayed word “accept” 631 and the non-presence of a checkmark in the checkbox adjacent to the displayed word “accept” 632, respectively. The representative of an institution by clicking, or otherwise selecting, the “check all” link 633 indicates that all images are acceptable. The representative of an institution by clicking, or otherwise selecting, the “clear all” link 634 can clear all accept marks. The representative of an institution by clicking, or otherwise selecting, the “submit” button 635 submits their choices.

FIG. 6G depicts an example user interface screen showing a summary of actions performed. In this example, no files were invalid and no files were rejected. If a file was rejected, such as the not accepted 234567123456789.jpg file of FIG. 6F, its filename can be displayed in the rejected resized images area of FIG. 6G 640. In the example of FIG. 6G all images have been accepted.

It is to be understood that the above description is intended to be illustrative, and not restrictive. Many other embodiments will be apparent to those of skill in the art upon reading and understanding the above description. It should be noted that embodiments discussed in different portions of the description or referred to in different drawings may be combined to form additional embodiments of the present application. The scope of the invention should, therefore, be determined with reference to the appended claims, along with the full scope of equivalents to which such claims are entitled.

1. A computer system, comprising:
a processor;
at least one input device;
at least one output device;
at least one communications interface device;
a storage device containing instructions for performing a method, the method comprising;
obtaining a photograph of at least one card user from an institution, the photograph in the form of at least one digital image;
analyzing the at least one digital image;
re-dimensioning the at least one digital image;
re-sizing a re-dimensioned digital image;
displaying a re-sized digital image to a representative of the institution;
receiving approval of the re-sized digital image from the representative; and
using the re-sized digital image to produce a photo-ID card device for the card user.

2. The computer system of claim 1, wherein the institution is an institution that provides financial cards to consumers.

3. The computer system of claim 1, wherein the obtaining a photograph of at least one card user includes obtaining a photograph of more then one card user.

4. The computer system of claim 1, wherein the digital image is a JPEG image.

5. The computer system of claim 1, wherein the digital image is a GIF image.

6. The computer system of claim 1, wherein the analyzing the at least one digital image includes analyzing the dimensions of the digital image.

7. The computer system of claim 6, wherein the re-dimensioning includes re-dimensioning the at least one digital image so that the height of the at least one digital image is substantially equal to the width.

8. The computer system of claim 6, wherein the re-dimensioning includes not re-dimensioning when the height and width of the digital image are substantially equal.

9. The computer system of claim 1, wherein the analyzing the at least one digital image includes analyzing the attributes of the digital image.

10. The computer system of claim 9, wherein the re-sizing includes altering the attributes of the digital image to some pre-set value.

11. The computer system of claim 9, wherein the re-sizing includes not altering the attributes of the digital image when the attribute is substantially equal to some pre-set value.

12. The computer system of claim 1, wherein the using the re-sized digital image to produce a photo-ID card device for the card user includes providing the digital image to a facility capable of producing photo-ID card devices.

13. A computer system, comprising:
a processor;
at least one input device;
at least one output device;
at least one communications interface device;
a storage device containing instructions for performing a method, the method comprising;
receiving a data item from an institution;
unpacking the data item to retrieve a plurality of digital images contained therein;
accessing at least one digital image of a plurality of digital images;
analyzing the at least one digital image;
re-dimensioning the at least one digital image;
re-sizing a re-dimensioned digital image;
displaying a re-sized digital image to a representative of the institution;
receiving approval of the re-sized digital image from the representative; and
using the re-sized digital image to produce a photo-ID card device for the card user.

14. The computer system of claim 13, wherein the data item is a series of files compressed so as to become one data file.

15. The computer system of claim 14, wherein the data item is a ZIP file.

16. The computer system of claim 13, wherein the institution is an institution that provides financial cards to consumers.

17. The computer system of claim 13, wherein the plurality of digital images are a plurality of JPEG images.

18. The computer system of claim 13, wherein the plurality of digital images plurality of GIF images.

19. The computer system of claim 13, wherein the analyzing the at least one digital image includes analyzing the dimensions of the digital image.

20. The computer system of claim 19, wherein the re-dimensioning includes re-dimensioning the at least one digital image so that the height of the at least one digital image is substantially equal to the width.

21. The computer system of claim 19, wherein the re-dimensioning includes not re-dimensioning when the height and width of the digital image are substantially equal.

22. The computer system of claim 13, wherein the analyzing the at least one digital image includes analyzing the attributes of the digital image.

23. The computer system of claim 22, wherein the re-sizing includes altering the attributes of the digital image to some pre-set value.

24. The computer system of claim 22, wherein the re-sizing includes not altering the attributes of the digital image when the attribute is substantially equal to some pre-set value.

25. The computer system of claim 13, wherein the using the re-sized digital image to produce a photo-ID card device for the card user includes providing the digital image to a facility capable of producing photo-ID card devices.

26. A method of processing images for card devices, comprising:
obtaining a photograph of at least one card user from an institution, the photograph in the form of at least one digital image;
analyzing the at least one digital image;
re-dimensioning the at least one digital image;
re-sizing a re-dimensioned digital image;
displaying a re-sized digital image to a representative of the institution;
receiving approval of the re-sized digital image from the representative; and
using the re-sized digital image to produce a photo-ID card device for the card user.

27. The method of claim 26, wherein the institution is an institution that provides financial cards to consumers.

28. The method of claim 26, wherein the obtaining a photograph of at least one card user includes obtaining a photograph of more then one card user.

29. The method of claim 26, wherein the digital image is a JPEG image.

30. The method of claim 26, wherein the digital image is a GIF image.

31. The method of claim 26, wherein the analyzing the at least one digital image includes analyzing the dimensions of the digital image.

32. The method of claim 31, wherein the re-dimensioning includes re-dimensioning the at least one digital image so that the height of the at least one digital image is substantially equal to the width.

33. The method of claim 31, wherein the re-dimensioning includes not re-dimensioning when the height and width of the digital image are substantially equal.

34. The method of claim 26, wherein the analyzing the at least one digital image includes analyzing the attributes of the digital image.

35. The method of claim 34, wherein the re-sizing includes altering the attributes of the digital image to some pre-set value.

36. The method of claim 34, wherein the re-sizing includes not altering the attributes of the digital image when the attribute is substantially equal to some pre-set value.

37. The method of claim 26, wherein the using the re-sized digital image to produce a photo-ID card device for the card user includes providing the digital image to a facility capable of producing photo-ID card devices.

38. A method of processing images for card devices, comprising:
receiving a data item from an institution;
unpacking the data item to retrieve a plurality of digital images contained therein;
accessing at least one digital image of a plurality of digital images;
analyzing the at least one digital image;
re-dimensioning the at least one digital image;
re-sizing a re-dimensioned digital image;
displaying a re-sized digital image to a representative of the institution;
receiving approval of the re-sized digital image from the representative; and
using the re-sized digital image to produce a photo-ID card device for the card user.

39. The method of claim 38, wherein the data item is a series of files compressed so as to become one data file.

40. The method of claim 39, wherein the data item is a ZIP file.

41. The method of claim 38, wherein the institution is an institution that provides financial cards to consumers.

42. The method of claim 38, wherein the plurality of digital images are a plurality of JPEG images.

43. The method of claim 38, wherein the plurality of digital images plurality of GIF images.

44. The method of claim 38, wherein the analyzing the at least one digital image includes analyzing the dimensions of the digital image.

45. The method of claim 44, wherein the re-dimensioning includes re-dimensioning the at least one digital image so that the height of the at least one digital image is substantially equal to the width.

46. The method of claim 44, wherein the re-dimensioning includes not re-dimensioning when the height and width of the digital image are substantially equal.

47. The method of claim 38, wherein the analyzing the at least one digital image includes analyzing the attributes of the digital image.

48. The method of claim 47, wherein the re-sizing includes altering the attributes of the digital image to some pre-set value.

49. The method of claim 47, wherein the re-sizing includes not altering the attributes of the digital image when the attribute is substantially equal to some pre-set value.

50. The method of claim 38, wherein the using the re-sized digital image to produce a photo-ID card device for the card user includes providing the digital image to a facility capable of producing photo-ID card devices.

51. A computer-readable medium having a program available thereon for causing a suitably programmed information-handling system to process digital images by performing the following when such program is executed on the information-handling system:
obtaining a photograph of at least one card user from an institution, the photograph in the form of at least one digital image;
analyzing the at least one digital image;
re-dimensioning the at least one digital image;
re-sizing a re-dimensioned digital image;
displaying a re-sized digital image to a representative of the institution;
receiving approval of the re-sized digital image from the representative; and
using the re-sized digital image to produce a photo-ID card device for the card user.

52. The computer-readable medium of claim 51, wherein the institution is an institution that provides financial cards to consumers.

53. The computer-readable medium of claim 51, wherein the obtaining a photograph of at least one card user includes obtaining a photograph of more then one card user.

54. The computer-readable medium of claim 51, wherein the digital image is a JPEG image.

55. The computer-readable medium of claim 51, wherein the digital image is a GIF image.

56. The computer-readable medium of claim 51, wherein the analyzing the at least one digital image includes analyzing the dimensions of the digital image.

57. The computer-readable medium of claim 56, wherein the re-dimensioning includes re-dimensioning the at least one digital image so that the height of the at least one digital image is substantially equal to the width.

58. The computer-readable medium of claim 56, wherein the re-dimensioning includes not re-dimensioning when the height and width of the digital image are substantially equal.

59. The computer-readable medium of claim 51, wherein the analyzing the at least one digital image includes analyzing the attributes of the digital image.

60. The computer-readable medium of claim 59, wherein the re-sizing includes altering the attributes of the digital image to some pre-set value.

61. The computer-readable medium of claim 59, wherein the re-sizing includes not altering the attributes of the digital image when the attribute is substantially equal to some pre-set value.

62. The computer-readable medium of claim 51, wherein the using the re-sized digital image to produce a photo-ID card device for the card user includes providing the digital image to a facility capable of producing photo-ID card devices.

63. A computer-readable medium having a program available thereon for causing a suitably programmed information-handling system to process digital images by performing the following when such program is executed on the information-handling system:
receiving a data item from an institution;
unpacking the data item to retrieve a plurality of digital images contained therein;
accessing at least one digital image of a plurality of digital images;
analyzing the at least one digital image;
re-dimensioning the at least one digital image;
re-sizing a re-dimensioned digital image;
displaying a re-sized digital image to a representative of the institution;
receiving approval of the re-sized digital image from the representative; and
using the re-sized digital image to produce a photo-ID card device for the card user.

64. The computer-readable medium of claim 63, wherein the data item is a series of files compressed so as to become one data file.

65. The computer-readable medium of claim 64, wherein the data item is a ZIP file.

66. The computer-readable medium of claim 63, wherein the institution is an institution that provides financial cards to consumers.

67. The computer-readable medium of claim 63, wherein the plurality of digital images are a plurality of JPEG images.

68. The computer-readable medium of claim 63, wherein the plurality of digital images plurality of GIF images.

69. The computer-readable medium of claim 63, wherein the analyzing the at least one digital image includes analyzing the dimensions of the digital image.

70. The computer-readable medium of claim 69, wherein the re-dimensioning includes re-dimensioning the at least one digital image so that the height of the at least one digital image is substantially equal to the width.

71. The computer-readable medium of claim 69, wherein the re-dimensioning includes not re-dimensioning when the height and width of the digital image are substantially equal.

72. The computer-readable medium of claim 63, wherein the analyzing the at least one digital image includes analyzing the attributes of the digital image.

73. The computer-readable medium of claim 72, wherein the re-sizing includes altering the attributes of the digital image to some pre-set value.

74. The computer-readable medium of claim 72, wherein the re-sizing includes not altering the attributes of the digital image when the attribute is substantially equal to some pre-set value.

75. The computer-readable medium of claim 63, wherein the using the re-sized digital image to produce a photo-ID card device for the card user includes providing the digital image to a facility capable of producing photo-ID card devices.
